(19) United States
(12) Patent Application Publication
(10) Pub. No.: US 2011/0263153 A1
(43) Pub. Date: Oct. 27, 2011

(54) CABLE-END CONNECTOR

(76) Inventor: Yueh-Chiung LU, Tao-Yuan County (TW)

(21) Appl. No.: 13/074,660

(22) Filed: Mar. 29, 2011

(30) Foreign Application Priority Data
Apr. 26, 2010 (TW) 099207616

(51) Int. Cl. H01R 9/05

(52) U.S. Cl. 439/578

(57) ABSTRACT

A cable-end connector includes a metal locknut having an axially extending center through hole, a rear orifice and a retaining structure, the retaining structure of the locknut defining a retaining groove and a stop edge, an elastically deformable cylindrical casing having an axial hole and a retaining structure for engagement with the retaining structure of the locknut and defining with the retaining structure of the locknut a clearance, the retaining structure of the cylindrical casing having a retaining flange for engaging the retaining groove of the retaining structure of the locknut, and a metal core tube mounted in the locknut and the cylindrical casing and having a rear stop flange for stopping against the stop edge of the locknut to block the clearance and to force the retaining flange of the retaining structure of the cylindrical casing into engagement with the retaining groove of the retaining structure of the locknut tightly, thereby sealing off outside moisture and enhancing the electromagnetic wave shielding effect.

This application claims the priority benefit of Taiwan patent application number 099207616, filed on Apr. 26, 2010.

### BACKGROUND OF THE INVENTION

1. Field of the Invention

The present invention relates electrical connectors and more particularly to a cable-end connector consisting of a metal locknut, an elastically deformable cylindrical casing, a metal core tube and a barrel for connecting a coaxial cable to a mating connector that effectively seals off outside moisture and greatly enhances the electromagnetic wave shielding effect.

2. Description of the Related Art

Following fast development of communication technology, signal transmission requires high stability and rapid speed. In consequence, different communication wire materials, from the early flat cable design to the modern round cable and optical cable designs, have been created to enhance signal transmission speed and capacity. Subject to the application of telephone technology, video technology and internet technology, global communication becomes faster and cheaper. Transmission of video signal through a cable assures signal stability and reliability. Therefore, closed-circuit TV is developed after the application of wireless TV and satellite TV. Establishing a closed-circuit television system requires installation of cables between the provider and the subscribers. When a cable is extended to the inside of a house, a cable-end connector must be used to connect the cable to an indoor electric or electronic device.

FIGS. 7 and 8 illustrate a cable-end connector according to the prior art. According to this design, the cable-end connector comprises a locknut A, a tubular connection member B and a core tube C. The locknut A comprises a center through hole A0 and a mounting structure A1 at one end of the center through hole A0. The mounting structure A1 comprises a stepped retaining groove A11 and a stop edge A12. The tubular connection member B comprises a coupling structure B1 coupled to the mounting structure A1 of the locknut A. The coupling structure B1 comprises a retaining flange B11 forced into engagement with the stepped retaining groove A11 of the mounting structure A1 of the locknut A. The core tube C is inserted into the center through hole A0 of the locknut A and the inside space B0 of the tubular connection member B. Further, a mating connector D is fastened to center through hole A0 of the locknut A of the cable-end connector to stop a front stop edge D11 of a metal shell D1 thereof at an end flange C1 of the he core tube C against the stop edge A12 of the locknut A, finishing the installation.

Further, the mating connector D comprises an insulative member D2 accommodated in the metal shell D1. Because the stop edge A12 of the locknut A is disposed adjacent to the stepped retaining groove A11 of the mounting structure A1, the end flange C1 of the he core tube C simply has its outer part be kept in contact with the stop edge A12 of the locknut A. As the electromagnetic wave shielding effect determines subject to the grounding contact area, a small grounding contact area cannot effectively eliminate signal interference or the problem of signal transmission instability during transmission of network data through the coaxial cable,

Further, due to a small contact area between the end flange C1 of the he core tube C and the stop edge A12 of the locknut A, outside moisture may pass to the inside of the cable-end connector to moisten the internal components, lowering the signal transmission performance. Further, when an excessive pressure is applied to the cable-end connector toward the mating connector D after the end flange C1 of the he core tube C is stopped against the stop edge A12 of the locknut A, the end flange C1 of the he core tube C may pass over the stop edge A12 of the locknut A, causing the end flange C1 of the he core tube C to be stuck in the stepped retaining groove A11 of the mounting structure A1.

Therefore, it is desirable to provide a cable-end connector, which achieves an excellent electromagnetic wave shielding effect and an excellent watertight effect and prevents sticking in the mating connector after installation.

### SUMMARY OF THE INVENTION

The present invention has been accomplished under the circumstances in view. It is the main object of the present invention to provide a cable-end connector, which effectively eliminates electromagnetic interference, effectively seals off outside moisture, and prevents sticking after connection with a mating connector.

To achieve this and other objects of the present invention, a cable-end connector is affixed to one end of a coaxial cable for connection to a mating connector, comprising a metal locknut, an elastically deformable cylindrical casing, a metal core tube and a barrel. The locknut comprises a retaining structure located on a front end thereof that comprises a retaining groove of substantially inverted [symbol] -shaped cross section and a stop edge disposed at one side of the retaining groove. The cylindrical casing comprises a retaining structure located on a rear end thereof that comprises a retaining flange extending around the periphery for engaging the retaining groove of the retaining structure of the locknut. The metal core tube comprises a rear stop flange that has a front stop edge stopped against the stop edge of the retaining structure of the locknut to enhance the electromagnetic wave shielding effect. After the cable-end connector is assembled with a mating connector, the front stop edge of the rear stop flange is stopped against the stop edge of the retaining structure of the locknut, and the retaining flange of the retaining structure of cylindrical casing is stopped against the periphery of the retaining groove of the retaining structure of the locknut and elastically deformed so that the retaining flange and the rear stop flange block the clearance between the retaining structure of the locknut and the retaining structure of the cylindrical casing, prohibiting outside moisture from passing through the clearance into the inside of the locknut or the inside of the cylindrical casing.

Further, the diameter of the rear stop flange is greater than the inner diameter of the retaining groove of the retaining structure of the locknut, and the contact area between the rear stop flange and the stop edge of the retaining structure of the locknut is large enough to enhance the electromagnetic wave shielding effect. Because there is a large contact area between the front stop edge of the rear stop flange of the core tube and the stop edge of the retaining structure of the locknut, the rear stop flange of the core tube can be shortened, saving much the consumption of the metal material and reducing the manufacturing cost.

Further, the retaining flange of the retaining structure of flexible cylindrical casing is stopped against the periphery of the retaining groove of the retaining structure of the locknut and the extension portion that suspends in the locknut is stopped by the rear stop flange of the core tube, and therefore the retaining flange is forced to deform elastically and to block the clearance between the retaining structure of the locknut and the retaining structure of the cylindrical casing, prohibiting outside moisture from passing through the clearance into the inside of the cylindrical casing to moisten the braided metal wrapper (woven copper shield) of the coaxial cable or to destruct the shielding effect.

### BRIEF DESCRIPTION OF THE DRAWINGS

FIG. 1 is an exploded view of a cable-end connector in accordance with the present invention.

FIG. 2 is a sectional side view of the cable-end connector in accordance with the present invention.

FIG. 3 is an enlarged view of a part of FIG. 2, illustrating the relationship between the retaining structure of the cylindrical casing and the retaining structure of the locknut.

FIG. 4 is a schematic sectional view of the present invention after connection of the cable-end connector with a coaxial cable.

FIG. 5 is a schematic sectional view of the present invention after connection of the cable-end connector with a coaxial cable and a mating connector.

FIG. 6 is an enlarged view of a part of FIG. 5, illustrating the relationship between the retaining structure of the cylindrical casing and the retaining structure of the locknut.

FIG. 7 is a sectional view illustrating a cable-end connector connected with a mating connector according to the prior art.

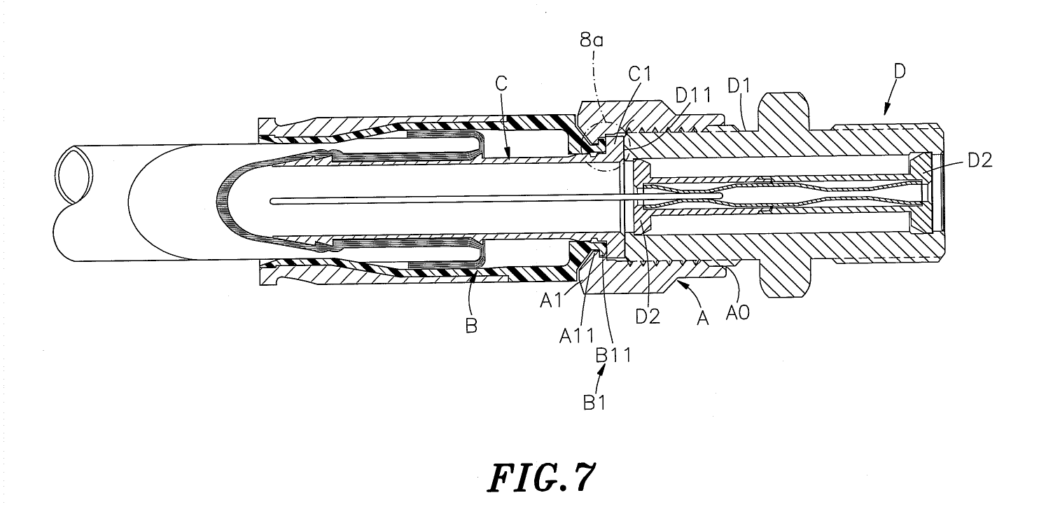

FIG. 8 is an enlarged view of a part of FIG. 7.

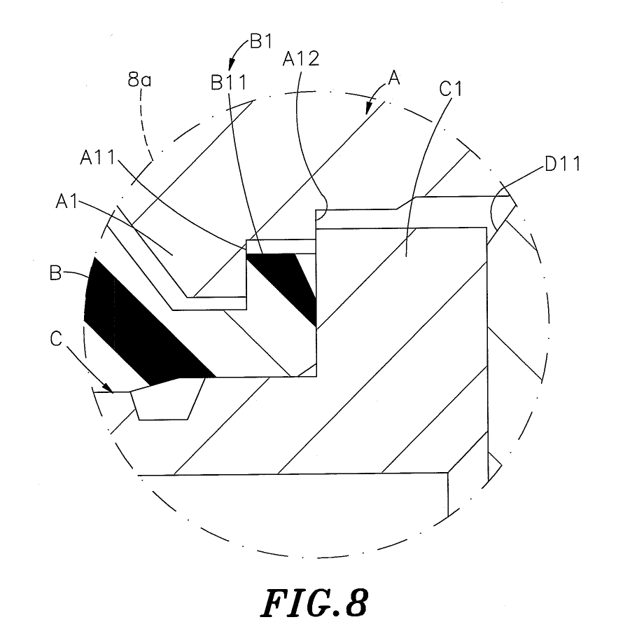

### DETAILED DESCRIPTION OF THE PREFERRED EMBODIMENT

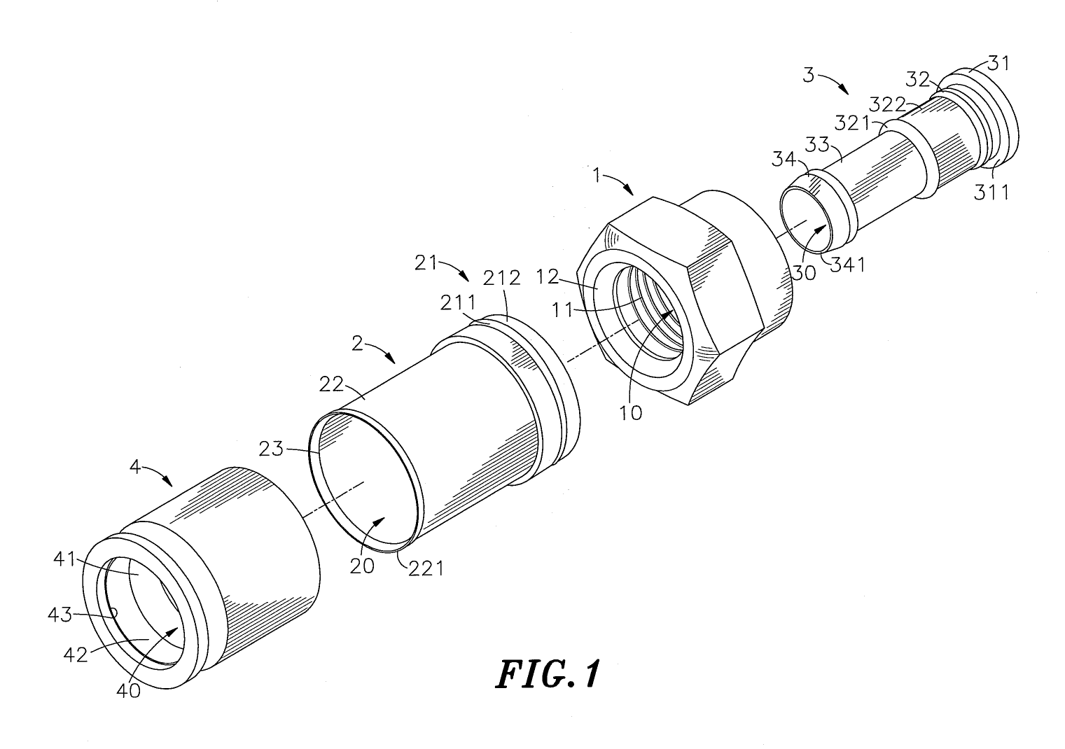

Referring to FIGS. 1˜3, a cable-end connector in accordance with the present invention is shown comprising a locknut 1, a cylindrical casing 2, a core tube 3 and a barrel 4.

The locknut 1 can be a polygonal nut or peripherally embossed circular nut made of metal, having an axially extending center through hole 10, a rear orifice 111 at one end, namely, the rear end of the center through hole 10, a retaining structure 12 at an opposite end, namely, the front end of the center through hole 10, and an inner thread 11 formed in the center through hole 10 between the rear orifice 111 and the retaining structure 12. The retaining structure 12 comprises a retaining groove 121 of substantially inverted [symbol] -shaped cross section extending around the inside wall of the locknut 1 and a stop edge 122 disposed at one side of the retaining groove 121 adjacent to the inner thread 11.

The cylindrical casing 2 is made of an elastic material, having an axial hole 20 extending through opposing front and rear ends of the deformable tubular body 22 thereof, a retaining structure 21 located on the rear end of the deformable tubular body 22 for engagement with the retaining structure 12 of the locknut 1, a mounting hole 210 surrounded by the retaining structure 21 in communication with the axial hole 20, an end edge 221 located on the front end of the deformable tubular body 22, and a contracted hole 23 surrounded by the end edge 221 in communication with the axial hole 20. The retaining structure 21 comprises a retaining flange 211 extending around the periphery corresponding to the retaining groove 121 of the retaining structure 12 of the locknut 1, and an extension portion 212 that protrudes over the stop edge 122 into the inside of the center through hole 10 of the locknut 1. After insertion of the retaining structure 21 of the cylindrical casing 2 into the front end of the locknut 1, a clearance 213 is left between the retaining structure 12 of the locknut 1 and the retaining structure 21 of the cylindrical casing 2.

The core tube 3 is made of metal and mounted in the center through hole 10 of the locknut 1 and the axial hole 20 of the cylindrical casing 2, having an axial hole 30 axially extending through opposing front and rear ends thereof, a rear stop flange 31 extending around the periphery of the rear end thereof around the axial hole 30, a barbed flange 34 located on the front end thereof around the axial hole 30 and defining a front end edge 341, a first tubular wall 322 and a second tubular wall 33 axially connected in series between the rear stop flange 31 and the barbed flange 34 around the axial hole 30 in a stepped manner, a hooked portion 321 extending around the periphery between the first tubular wall 322 and the second tubular wall 33, and a packing portion 32 connected between the second tubular wall 322 and the rear stop flange 31 around the axial hole 30. The rear stop flange 31 has a diameter greater than the inner diameter of the retaining groove 121 of the retaining structure 12 of the locknut 1, and a front stop edge 311 for stopping against the stop edge 122 of the retaining structure 12 of the locknut 1 to block the clearance 213.

The barrel 4 defines therein a coupling hole 40 for receiving the cylindrical casing 2, having a tapered inner surface portion 41 located on the middle around the coupling hole 40, a hooked portion 43 disposed near one end thereof around the coupling hole 40 and a contracted inner wall portion 42 connected between the tapered inner surface portion 41 and the hooked portion 43 around the coupling hole 40.

Further, the packing portion 32 of the core tube 3 can be peripherally embossed to provide an embossed pattern that enhances connection tightness between the peripheral wall of the mounting hole 210 of the cylindrical casing 2 and the core tube 3. The embossed pattern can be formed of one or a number of endless ribs extending around the periphery of the packing portion 32 of the core tube 3, or a plurality of raised portions, protruding portions or hooked portions evenly distributed over the periphery of the packing portion 32 of the core tube 3.

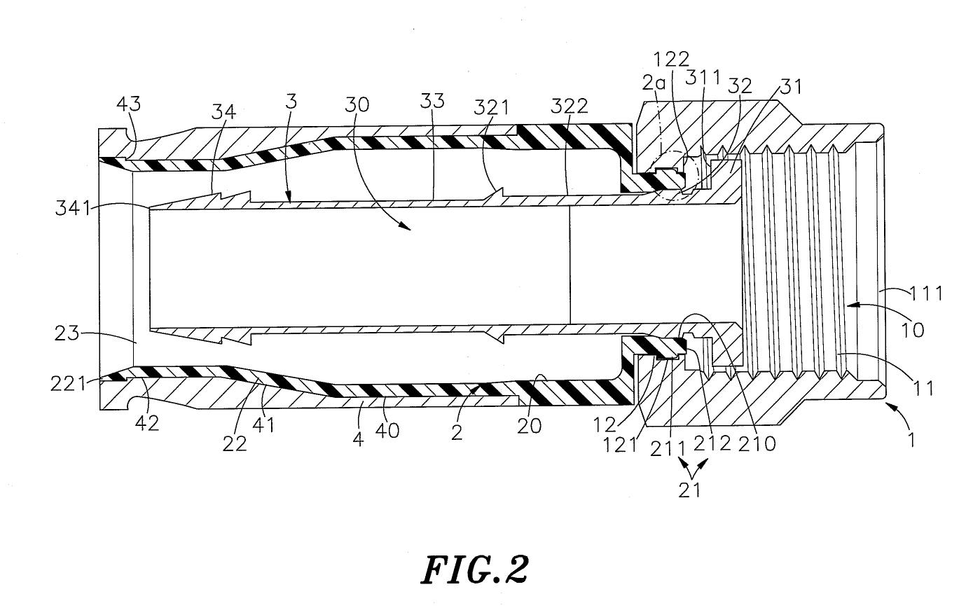

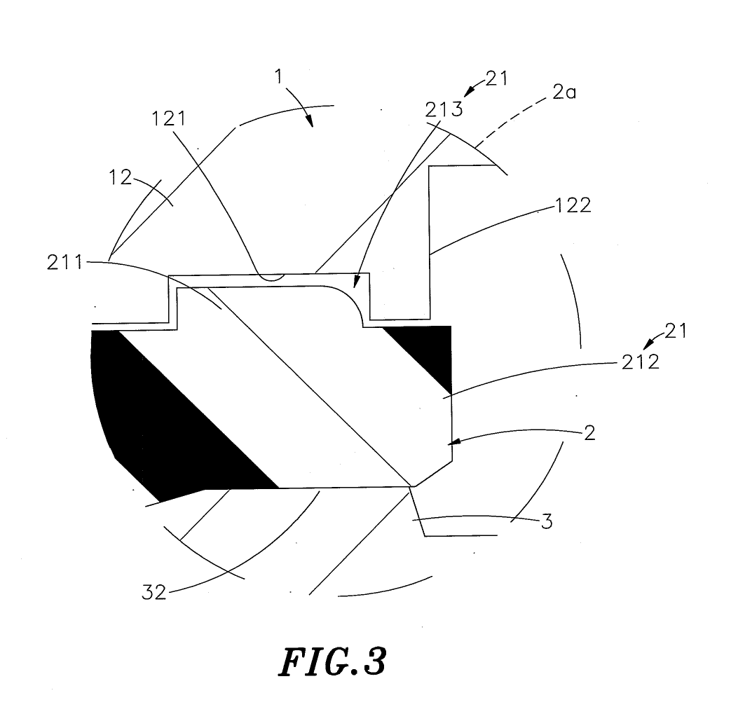

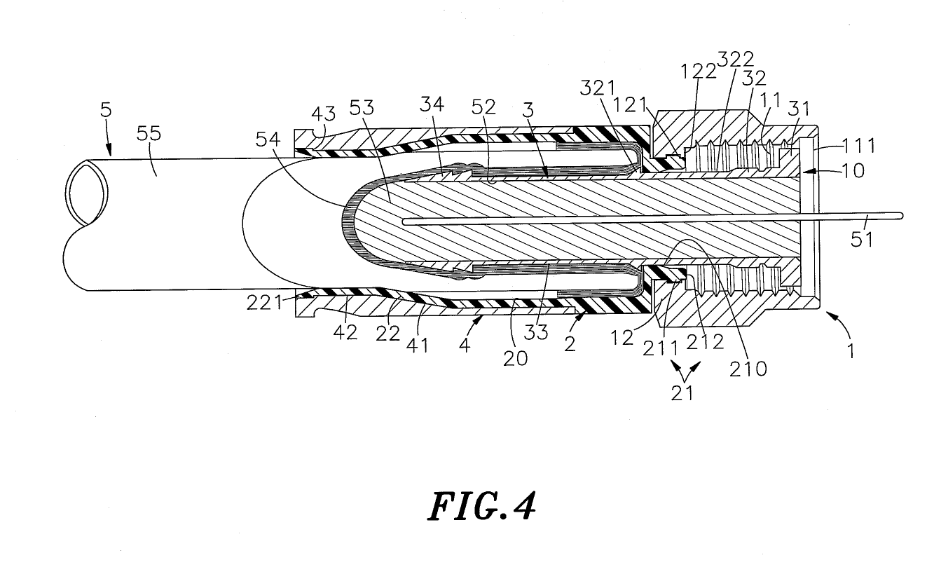

Referring to FIG. 4 and FIGS. 2 and 3 again, the cable-end connector of the invention is to be used with a coaxial cable 5 that comprises an outer plastic sheath 55, a braided metal wrapper (woven copper shield) 54 surrounded by the outer plastic sheath 55, an inner dielectric insulator 53 surrounded by the braided metal wrapper (woven copper shield) 54, an aluminum foil shield 52 surrounded by the inner dielectric insulator 53 and a copper core (center conductor) 51 surrounded by the aluminum foil shield 52. The design of the contracted hole 23 of the cylindrical casing 2 and the arrangement of the front end edge 341 of the barbed flange 34 of the core tube 3 facilitate quick alignment of the coaxial cable 5. When fastening the cable-end connector to the coaxial cable 5, insert the copper core (center conductor) 51, aluminum foil shield 52 and inner dielectric insulator 53 of the coaxial cable 5 into the axial hole 30 of the core tube 3 manually by hand to have the braided metal wrapper (woven copper shield) 54 and outer plastic sheath 55 of the coaxial cable 5 be sleeved onto the first tubular wall 33 and barbed flange 34 of the core tube 3. When pushing the coaxial cable 5 forwardly relative to the cable-end connector, the packing portion 32 of the core tube 3 will be moved away from the mounting hole 210 of the mounting base 21 of the cylindrical casing 2, allowing axial movement of the second tubular wall 322 of the core tube 3 in the mounting hole 210 of the cylindrical casing 2. When the core tube 3 is being moved axially relative to the cylindrical casing 2 by the inserted coaxial cable 5, the hooked portion 321 will be stopped at the inner end of the mounting hole 210 of the mounting base 21 of the cylindrical casing 2, prohibiting falling of the core tube 3 out of the locknut 1. Thus, the coaxial cable 5 and the cable-end connector are temporarily coupled together.

The coaxial cable 5 and the cable-end connector are then put in a crimping tool (not shown), and then the crimping tool is operated to move the coaxial cable 5 and the core tube 3 into the center through hole 10 of the locknut 1, forcing the packing portion 32 into the mounting hole 210 of the mounting base 21 of the cylindrical casing 2. At this time, the braided metal wrapper (woven copper shield) 54 and outer plastic sheath 55 of the coaxial cable 5 are synchronously moved in the axial hole 20 of the cylindrical casing 2 and stopped by the contracted hole 23 of the cylindrical casing 2, causing the barbed flange 34 of the core tube 3 to be engaged into the inside of the braided metal wrapper (woven copper shield) 54 of the coaxial cable 5.

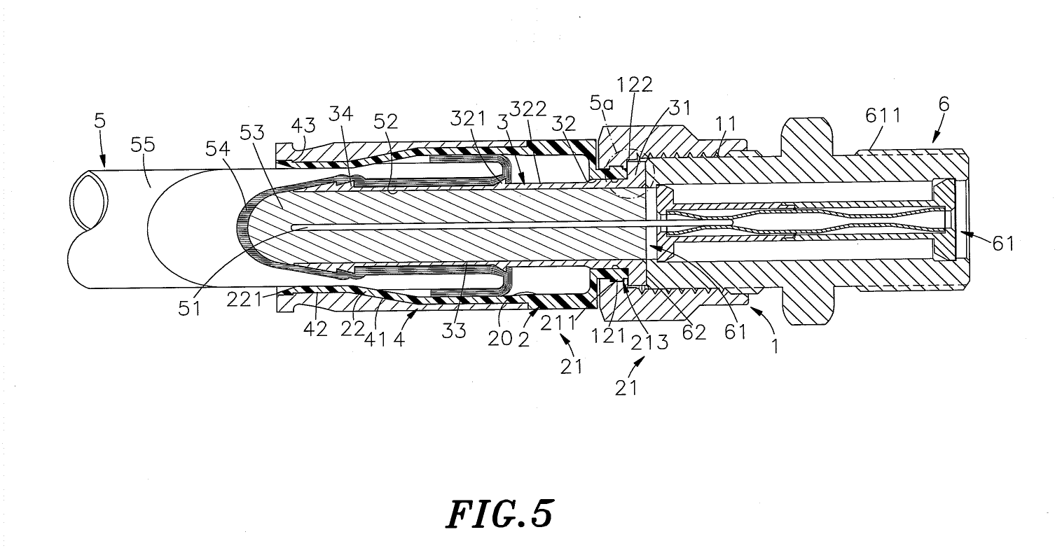

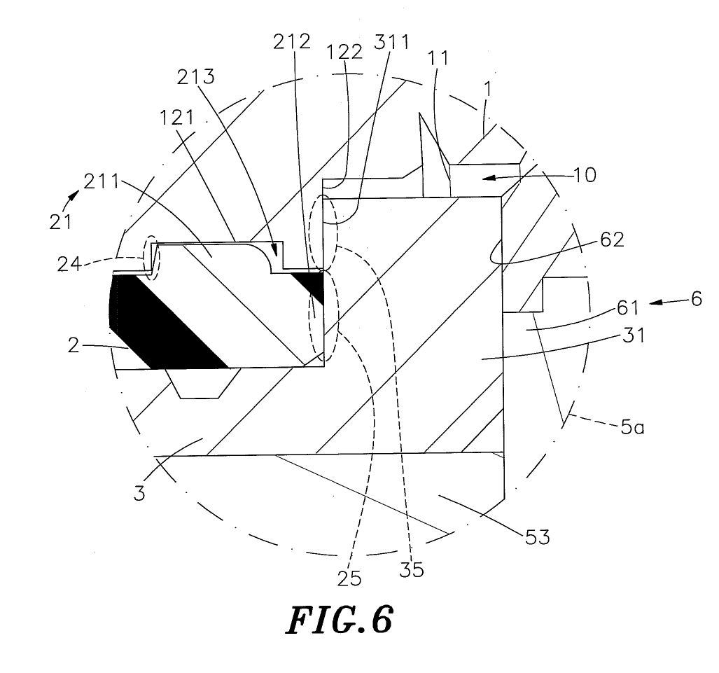

Referring to FIGS. 5 and 6 and FIGS. 2˜4 again, when the core tube 3 is moved into the inside of the center through hole 10 of the locknut 1, the rear stop flange 31 of the core tube 3 will be forced against the extension portion 212 of the retaining structure 21 of the cylindrical casing 2 to move the cylindrical casing 2 forwards relative to the locknut 1 to the position where the retaining flange 211 of the retaining structure 21 of the cylindrical casing 2 to move the cylindrical casing 2 is stopped against the periphery of the retaining groove 121 of the retaining structure 12 of the locknut 1. At this time, the extension portion 212 suspends in the center through hole 10 of the locknut 1, and the core tube 3 is continuously moved forwards to abut the front stop edge 311 of the rear stop flange 31 against the stop edge 122 of the retaining structure 12 and to keep the extension portion 212 in flush with the stop edge 122 of the retaining structure 12. At this time, the retaining flange 211 of the retaining structure 21 of the cylindrical casing 2 is forced against the periphery of the retaining groove 121 of the retaining structure 12 of the locknut 1 and elastically deformed to block the clearance 213. As the clearance 213 is continuously curved, external moisture is difficult to pass through the clearance 213 into the center through hole 10 of the locknut 1. Further, by means of stopping the retaining flange 211 of the retaining structure 21 of the cylindrical casing 2 against the periphery of the retaining groove 121 of the retaining structure 12 of the locknut 1 to form a first blocking zone 24 and stopping the rear stop flange 31 of the core tube 3 against the extension portion 212 of the retaining structure 21 of the cylindrical casing 2 to form a second blocking zone 25, and stopping the front stop edge 311 of the rear stop flange 31 of the core tube 3 against the stop edge 122 of the retaining structure 12 of the locknut 1 to form a third blocking zone 35, the invention effectively prohibits permeation of outside moisture from passing through the clearance 213 into the center through hole 10 of the locknut 1.

Referring to FIGS. 2, 5 and 6 again, after connection with the coaxial cable 5, the cable-end connector is connected to a mating connector 6. When connecting the cable-end connector and the mating connector 6, insert a connection end 61 of the mating connector 6 into the center through hole 10 of the locknut 1, and then rotate the mating connector 6 relative to the cable-end connector to force an outer thread 611 at the periphery of the connection end 61 of the mating connector 6 into engagement with the inner thread 11 of the locknut 1. When rotating the mating connector 6 toward the inside of the center through hole 10 of the locknut 1 to thread the outer thread 611 into mesh with the inner thread 11 of the locknut 1, the metal front edge, referenced by 62, of the connection end 61 of the mating connector 6 will be stopped against the rear side of the rear stop flange 31 opposite to the front stop edge 311 and first tubular wall 32 of the core tube 3. Because the diameter of the rear stop flange 31 is greater than the inner diameter of the retaining groove 121 of the retaining structure 12 of the locknut 1, the contact area between the rear stop flange 31 and the stop edge 122 of the retaining structure 12 of the locknut 1 is large enough to enhance the electromagnetic wave shielding effect and to prohibit excessive insertion of the mating connector 6 into the cable-end connector that may cause the rear stop flange 31 to move over the stop edge 122 of the retaining structure 12 of the locknut 1 and jammed in the retaining structure 12 of the locknut 1. As the industrial technology and specifications of coaxial cable and cable-end connector have been well developed, making improvement in this field is difficult. Under this situation, the improvement of the invention provides significant effects.

Further, because there is a large contact area between the front stop edge 311 of the rear stop flange 31 of the core tube 3 and the stop edge 122 of the retaining structure 12 of the locknut 1, the rear stop flange 31 of the core tube 3 can be shortened, saving much the consumption of the metal material and reducing the manufacturing cost.

It is to be understood that the above description is simply an example of the present invention and not intended as a limitation of the present invention. In general, the invention provides a cable-end connector, which comprises a locknut 1 having a retaining structure 12 located on a front end thereof that comprises a retaining groove 121 of substantially inverted [symbol] -shaped cross section and a stop edge 122 disposed at one side of the retaining groove 121, a flexible cylindrical casing 2 having a retaining structure 21 located on a rear end thereof that comprises a retaining flange 211 extending around the periphery for engaging the retaining groove 121 of the retaining structure 12 of the locknut 1, a metal core tube 3 that has a rear stop flange 31 that has a front stop edge 311 stopped against the stop edge 122 of the retaining structure 12 of the locknut 1 to enhance the electromagnetic wave shielding effect. Upon stoppage of the front stop edge 311 of the rear stop flange 31 against the stop edge 122 of the retaining structure 12 of the locknut 1, the retaining flange 211 of the retaining structure 21 of flexible cylindrical casing 2 is stopped against the periphery of the retaining groove 121 of the retaining structure 12 of the locknut 1 and elastically deformed so that the retaining flange 211 and the rear stop flange 31 block the clearance 213 between the retaining structure 12 of the locknut 1 and the retaining structure 21 of the cylindrical casing 2, prohibiting outside moisture from passing through the clearance 213 into the center through hole 10 of the locknut 1 or the axial hole 20 of the cylindrical casing 2. Therefore, the invention achieves an excellent waterproof effect.

In actual use, the cable-end connector of the present invention has the following advantages:

1. After the cable-end connector is assembled with a mating connector 6, the front stop edge 311 of the rear stop flange 31 is stopped against the stop edge 122 of the retaining structure 12 of the locknut 1, and the retaining flange 211 of the retaining structure 21 of flexible cylindrical casing 2 is stopped against the periphery of the retaining groove 121 of the retaining structure 12 of the locknut 1 and elastically deformed so that the retaining flange 211 and the rear stop flange 31 block the clearance 213 between the retaining structure 12 of the locknut 1 and the retaining structure 21 of the cylindrical casing 2, prohibiting outside moisture from passing through the clearance 213 into the center through hole 10 of the locknut 1 or the axial hole 20 of the cylindrical casing 2.

2. The diameter of the rear stop flange 31 is greater than the inner diameter of the retaining groove 121 of the retaining structure 12 of the locknut 1, and the contact area between the rear stop flange 31 and the stop edge 122 of the retaining structure 12 of the locknut 1 is large enough to enhance the electromagnetic wave shielding effect. Because there is a large contact area between the front stop edge 311 of the rear stop flange 31 of the core tube 3 and the stop edge 122 of the retaining structure 12 of the locknut 1, the rear stop flange 31 of the core tube 3 can be shortened, saving much the consumption of the metal material and reducing the manufacturing cost.

3. The retaining flange 211 of the retaining structure 21 of flexible cylindrical casing 2 is stopped against the periphery of the retaining groove 121 of the retaining structure 12 of the locknut 1 and the extension portion 212 that suspends in the center through hole 10 of the locknut 1 is stopped by the rear stop flange 31 of the core tube 3, and therefore the retaining flange 211 is forced to deform elastically and to block the clearance 213 between the retaining structure 12 of the locknut 1 and the retaining structure 21 of the cylindrical casing 2, prohibiting outside moisture from passing through the clearance 213 into the axial hole 20 of the cylindrical casing 2 to moisten the braided metal wrapper (woven copper shield) 54 of the coaxial cable 5 or to destruct the shielding effect.

In conclusion, the invention provides a cable-end connector consisting of a locknut, a cylindrical casing, a core tube and a barrel. The flexible cylindrical casing has a retaining structure located on its one end and fastened to a retaining structure at one end of the locknut. The core tube is inserted into the locknut and the cylindrical casing to force the retaining flange of the retaining structure of the flexible cylindrical casing into positive engagement with the retaining groove of the retaining structure of the metal locknut. the rear stop flange of the metal core tube is stopped against and the stop edge of the retaining structure of the locknut, the retaining flange of the retaining structure of flexible cylindrical casing is stopped against the periphery of the retaining groove of the retaining structure of the locknut and elastically deformed so that the clearance between the retaining structure of the locknut and the retaining structure of the cylindrical casing is blocked, prohibiting outside moisture from passing through the clearance into the inside of the locknut or the inside of the cylindrical casing, and the contact area between the rear stop flange of the metal core tube and the stop edge of the retaining structure of the locknut is large enough to enhance the electromagnetic wave shielding effect.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A cable-end connector, comprising:
a locknut made of metal, said locknut comprising an axially extending center through hole, a rear orifice located on a rear end of said center through hole, a retaining structure located on a front end of said center through hole and an inner thread formed in said center through hole, the retaining structure of said locknut comprising a retaining groove extending around an inside wall of said locknut and a stop edge disposed at one side of said retaining groove adjacent to said inner thread, said retaining groove having a substantially inverted [symbol] -shaped cross section;
a cylindrical casing made of an elastic material, said cylindrical casing comprising an axial hole extending through opposing front and rear ends of an elastically deformable tubular body thereof, a retaining structure located on a rear end of said elastically deformable tubular body for engagement with the retaining structure of said locknut and defining with the retaining structure of said locknut a clearance, the retaining structure of said cylindrical casing comprises a retaining flange extending around the periphery thereof for engaging the retaining groove of the retaining structure of said locknut; and
a core tube made of metal and mounted in the center through hole of said locknut and the axial hole of said cylindrical casing, said core tube comprising an axial hole axially extending through opposing front and rear ends thereof and a rear stop flange extending around the periphery of the rear end thereof for stopping against the stop edge of said locknut to block said clearance and to force the retaining flange of the retaining structure of said cylindrical casing into engagement with the retaining groove of the retaining structure of said locknut tightly, said rear stop flange having a diameter greater than the inner diameter of the retaining groove of the retaining structure of said locknut.

2. The cable-end connector as claimed in claim 1, wherein said locknut is a polygonal nut.

3. The cable-end connector as claimed in claim 1, wherein said locknut is a peripherally embossed circular nut.

4. The cable-end connector as claimed in claim 1, wherein the retaining structure of said cylindrical casing further comprises an extension portion that protrudes over the stop edge of said locknut into the inside of the center through hole of said locknut for stopping against the rear stop flange of said core tube.

5. The cable-end connector as claimed in claim 1, wherein said cylindrical casing further comprises an end edge located on the front end of said elastically deformable tubular body and a contracted hole surrounded by said end edge, and is mounted with a barrel, said barrel comprising a coupling hole that accommodates said cylindrical casing, a tapered inner surface portion located on a middle part thereof around said coupling hole, a hooked portion disposed near one end thereof around said coupling hole for engaging the periphery of said cylindrical casing and a contracted inner wall portion connected between said tapered inner surface portion and said hooked portion around said coupling hole for compressing the said elastically deformable tubular body of said cylindrical casing.

6. The cable-end connector as claimed in claim 1, wherein said cylindrical casing further comprises a mounting hole surrounded by the retaining structure of said cylindrical casing in communication with the axial hole of said cylindrical casing; said core tube further comprises a barbed flange located on the front end thereof, a first tubular wall and a second tubular wall axially connected in series between said rear stop flange and said barbed flange in a stepped manner, a hooked portion extending around the periphery between said first tubular wall and said second tubular wall, and a packing portion connected between said second tubular wall and said rear stop flange for engaging the mounting hole of said cylindrical casing.
